(19) United States
(12) Patent Application Publication
(10) Pub. No.: US 2012/0225320 A1
(43) Pub. Date: Sep. 6, 2012

(54) DEPOSITION OF DOPED ZnO FILMS ON POLYMER SUBSTRATES BY UV-ASSISTED CHEMICAL VAPOR DEPOSITION

(75) Inventors: Chen Xu, Wayne, PA (US); Gary S. Silverman, King of Prussia, PA (US); Roman Y. Korotkov, Boothwyn, PA (US); Robert G. Smith, Horsham, PA (US)

(73) Assignee: Arkema Inc., King of Prussia, PA (US)

(21) Appl. No.: 13/501,471

(22) PCT Filed: Oct. 14, 2010
(86) PCT No.: PCT/US10/52599

§ 371 Date: May 23, 2012

Related U.S. Application Data
(60) Provisional application No. 61/251,884, filed on Oct. 15, 2009.

(51) Int. Cl. B32B 27/06; B05D 3/06

(52) U.S. Cl. 428/702; 427/558

(57) ABSTRACT

The invention provides a method of forming a layer on a polymer substrate comprises a polymer substrate with at least one precursor, and applying ultraviolet light to decompose the at least one precursor and deposit a layer onto the polymer substrate. Also provided is a doped layer comprising zinc oxide deposited on a polymer substrate obtained by introducing at least one precursor comprising zinc and a dopant into a vessel containing a polymer substrate, and applying an ultraviolet light to decompose the at least one precursor and to deposit a layer comprising doped zinc oxide onto the polymer substrate.

### FIELD OF THE INVENTION

The invention relates to chemical vapor deposition processes for depositing DOPED zinc oxide films onto polymer substrates.

### BACKGROUND OF THE INVENTION

Transparent conducting oxides (TCOs) are metal oxides used in optoelectronic devices, such as flat panel displays and photovoltaics. In particular, TCOs are a class of materials that are both optically transparent and electrically conducting. Tin-doped indium oxide (ITO), one type of TCO, has been extensively employed as TCO layers in a variety of applications, such as thin film transistor (TFT), liquid crystal displays (LCD), plasma display panels (PDP), organic light emitting diodes (OLEDs), solar cells, electroluminescent devices, and radio frequency identication devices (RFID). Although the chemical stability of ITO is quite adequate for many applications, ITO films may not be stable in reducing conditions and may degrade under high electric fields, resulting in formation of active indium and oxygen species that may diffuse into the organic layers. Furthermore, due to the scarcity of indium and rapidly growing markets, it is expensive and challenging to fabricate large-scale next-generation flat panel display and photovoltaic devices. Therefore, new TCO materials to replace or improve existing ITO materials are desirable for future technologies. In particular, new materials are desirably low-cost and may have comparable or better electrical and optical properties in comparison to ITO.

TCO films are often applied to glass substrates. There is, however, a strong need to replace the glass substrates with cheaper, lightweight, and/or flexible substrates. The properties of TCO films often depend on the substrate temperature during deposition. Certain substrates, such as polymer substrates, however, may be heat sensitive and may stiffer from dimensional and structural instability when exposed to higher temperatures (such as 300-500° C.). But even at lower temperatures (such as 100-150° C.), the dimensional stability of many polymers may be poor. In addition, temperature exposure may lead to increased film stress and failure by cracking from the substrate. It is therefore difficult for the TCO films to achieve desirable electrical and optical properties at even low processing temperatures. Several techniques, such as pulsed laser deposition (PLD) and RF magnetron sputtering, have been used to deposit TCO films on polymer substrates at room temperature. These techniques, however, also have additional limitations, such as lower optoelectronic properties, low deposition rate, high vacuum, small area of deposition, etc.

### SUMMARY OF THE INVENTION

Aspects of the present invention include methods for producing high quality TCO films on polymer substrates at lower processing temperatures and the products obtainable therefrom.

According to an embodiment of the present invention, a method of forming a layer on a polymer substrate comprises contacting a polymer substrate with at least one precursor, and applying ultraviolet light to decompose at least one precursor and deposit a layer onto the polymer substrate.

According to an embodiment of the present invention, a method of forming a doped layer comprised of zinc oxide on a polymer substrate comprises contacting a polymer substrate with at least one precursor comprising zinc and a dopant, and applying an ultraviolet light to decompose the at least one precursor and to deposit a layer comprising doped zinc oxide onto the polymer substrate.

According to another embodiment of the present invention, a doped layer comprising zinc oxide deposited on a polymer substrate is obtained by introducing at least one precursor comprising zinc, a dopant, and an oxygen source into a mixing chamber that passes through a UV chamber subsequently depositing onto a polymer substrate a layer comprising doped zinc oxide

According to another embodiment of the present invention, a method of forming a layer on a polymer substrate comprises contacting a polymer substrate with at least one precursor, and applying ultraviolet light to decompose at least one precursor and deposit a layer onto the polymer substrate at a temperature of less than about 200° C.

### BRIEF DESCRIPTION OF THE DRAWINGS

FIG. 1 is an optical transmission of substrate PVDF and ZnO on PVDF.

FIG. 2 is an XRD patterns of ZnO films on glass and PVDF substrates.

FIG. 3 is a UV spectrum of the high pressure Hg metal halide lamp.

FIG. 4 is a plot of resistivity of Al-doped ZnO films as a function of time after deposition.

FIG. 5 is theta-theta XRD patterns probing the bulk of the samples.

FIG. 6 is grazing incidence XRD patterns (1 deg.) probing the top surface of the samples.

FIG. 7 is a depth profile of sample 170-2.

FIG. 8 is a depth profile of sample 171-1.

### DETAILED DESCRIPTION OF THE INVENTION

Aspects of the present invention include methods of forming a layer on a polymer substrate and the products obtained therefrom. In particular, embodiments of the present invention provide a process for deposition of doped zinc oxide films on polymer substrates.

As used herein, unless specified otherwise, the values of the constituents or components are expressed in weight percent or % by weight of each ingredient. All values provided herein include up to and including the endpoints given.

The polymer substrates suitable for use in the present invention include any of the substrates capable of having a layer deposited thereon, for example, in a chemical vapor deposition process. Transparent polymer substrates are especially suitable. For example, substrate materials having a glass transition point (Tg) of less than 400° C., wherein the coating is deposited at a substrate temperature of less than 400° C. (e.g., between about 80° C. and 400° C.), may be used. In a preferred embodiment, the polymer substrate is transparent (e.g., greater than 80% transmission).

Illustrative examples of suitable substrate materials include, but are not limited to, polymeric substrates such as polyacrylates (e.g., polymethylmethacrylate (pMMA)), polyesters (e.g., polyethylene terephthalate (PET), polyethylene naphthalate (PEN), polyaryletheretherketone (PEEK), and polyetherketoneketone (PEKK)), polyamides, polyimides, polycarbonates and the like. In an embodiment of the present invention, the polymer substrate is selected from the group consisting of fluoropolymer resins, polyesters, polyacrylates, polyamides, polyimides, and polycarbonates. In another embodiment, the polymer substrate is selected from the group consisting of polyvinylidene fluoride (PVDF), polyethylene terephthalate (PET), polyethylene naphthalate (PEN), and polymethyl methacrylate (PMMA). In a preferred embodiment, the polymer substrate is polyvinylidene fluoride (PVDF). In another preferred embodiment, the polymer substrate is polyethylene terephthalate (PET) or polyethylene naphthalate (PEN). In another preferred embodiment, the polymer substrate is polyetherketoneketone (PEKK) or polymethylmethacrylate (pMMA).

Other components may also be compounded together with the polymer. For example, fillers, stabilizers, colorants, etc. may be added to and incorporated with the polymer or applied to the surface of the polymer based on the properties desired.

The substrate may be in any suitable form. For instance, the polymer substrate may be a sheet, a film, a composite, or the like. In a preferred embodiment, the polymer substrate is a film in the form of a roll (e.g., for roll to roll processing). The polymer substrate may be of any suitable thickness based on the application. For example, the polymer substrate may be less than about 15 mils (thousandths of an inch) in thickness.

According to an embodiment of the present invention, a method of forming a layer on a polymer substrate comprises contacting a polymer substrate with at least one precursor, simultaneously applying ultraviolet light to decompose at least one precursor and deposit a layer of TCO onto the polymer substrate.

Ultraviolet (UV) light is applied to decompose at least one precursor. Ultraviolet light is electromagnetic radiation with a wavelength shorter than that of visible light, but longer than X-rays, e.g., in the range of 10 nm to 400 nm with photon energy from 3 eV to 124 eV. In a preferred embodiment, the wavelength of the UV light is in the range of 180-310 nm, preferably 200-220 nm. The light may be monochromic in certain embodiments. The UV light may photochemically decompose and/or activate the precursors. Additionally, the UV light may deposit or help to deposit the TCOs onto the polymer substrates.

In one embodiment, the UV light may be applied during a chemical vapor deposition process. Chemical vapor deposition (CVD) is a chemical process used to produce high-purity, high-performance solid materials and is often used in the semiconductor industry to produce thin films. In a typical CVD process, a substrate is exposed to one or more volatile precursors, which react and/or decompose on the substrate surface to produce the desired deposit or film. The deposit or film may contain one or more types of metal atoms, which may be in the form of metals, metal oxides, metal nitrides or the like following reaction and/or decomposition of the precursors. Any volatile by-products that are also produced are typically removed by gas flow through the reaction chamber.

Chemical vapor deposition, however, may be limited especially with respect to the substrates used. For example, the deposition temperature for most atmospheric pressure chemical vapor deposition (APCVD) process is 400-700° C., which is beyond the thermal stability temperature for most polymers. It was found that when the temperature was lowered (e.g., to about 150° C.) to accommodate polymer substrates without using the UV-assisted chemical vapor deposition, zinc oxide films with low conductivity were deposited. A potential issue with lower temperature deposition may be that the energy supplied at lower temperatures may not be sufficient to decompose and activate the precursors. It was therefore determined that an additional energy source was necessary, for example, to activate the precursors and deposit the TCO films with good optoelectrical properties. Accordingly, embodiments of the present invention utilize UV to photochemically decompose and/or activate the precursors, and/or successfully deposit high quality TCO films on polymer substrates.

The polymer substrate is contacted with at least one precursor. The precursor may comprise one or more types of precursors. The precursor(s) may be any suitable precursor known to one skilled in the art. The precursor may be introduced into the system in any suitable form. In an embodiment, the precursor(s) are preferably introduced in a gaseous phase (i.e., vapor form). For example, suitable vapor precursors for use in a chemical vapor deposition process are preferred. It is desirable that the chemical vapor deposition (CVD) precursors are both volatile and easily handled. Desirable precursors exhibit sufficient thermal stability to prevent premature degradation or contamination of the substrate and at the same time facilitate easy handling. In a preferred embodiment, the precursor should be depositable at a relatively low temperature in order to preserve the characteristics of the substrate or of the underlying layers previously formed. Additionally, precursors for use in codeposition processes are preferred to have minimal or no detrimental effect on the coherent deposition of layers when used in the presence of other precursors.

In an embodiment of the present invention, the at least one precursor comprises zinc. Any suitable zinc-containing compounds may be utilized. The zinc compound preferably is introduced in a gaseous form. The zinc may be introduced, for example, as an oxide, a carbonate, a nitrate, a phosphate, a sulfide, a halogenated zinc compound, a zinc compound containing organic substituents and/or ligands, etc.

For example, the zinc-containing compound may correspond to the general formula:

R¹R²Zn or R¹R²Zn·[L]ₙ

where R¹ and R² are the same or different and are selected from alkyl groups or aryl groups, L is a ligand, n is 1 if L is a polydentate ligand (e.g., a bidentate or tridentate ligand) and n is 2 if L is a monodentate ligand. Suitable ligands include, for example, ethers, amines, amides, esters, ketones, and the like. A polydentate ligand may contain more than one type of functional group capable of coordinating with the zinc atom.

Other suitable zinc-containing compounds include, but are not limited to, compounds of the general formula:

R¹R²Zn·L_{z} or R¹R²Zn·[R³R⁴N(CHR⁵)ₙ(CH₂)ₘ(CHR⁶)ₙNR⁷R⁸]

where R¹⁻⁸ can be the same or different alkyl or aryl groups such as methyl, ethyl, isopropyl, n-propyl, n-butyl, sec-butyl, phenyl or substituted phenyl, and may include one or more fluorine-containing substituents, L is a oxygen-based, neutral ligand such as an ether, ketone or ester and z=0-2. R⁵ and R⁶ can be H or alkyl or aryl groups, n can be 0 or 1, and m can be 1-6 if n is 0, and in can be 0-6 if n is 1.

Other suitable zinc compounds may include dialkyl zinc glycol alkyl ethers of the general formula:

R⁹₂Zn·[R¹⁰O(CH₂)₂O(CH₂)₂OR¹⁰]

where R⁹ is a short chain, saturated organic group having 1 to 4 carbon atoms (with the two R⁹ groups being the same or different) and R¹⁰ is a short chain, saturated organic group having 1 to 4 carbon atoms. Preferably, R⁹ is a methyl or ethyl group and R¹⁰ is a methyl group and is referred to as diethylzinc (DEZ) diglyme having the formula:

Et₂Zn·[CH₃O(CH₂)₂O(CH₂)₂OCH₃]

Specific examples of suitable zinc-containing compounds include, for example, diethyl and dimethyl zinc adducts such as diethylzinc·TEEDA (TEEDA=N,N,N,N′-tetraethyl ethylenediamine), diethylzinc·TMEDA (TMEDA N,N,N′,N′-tetramethyl ethylenediamine), diethylzinc·TMPDA (TMPDA=N,N,N′,N′-tetramethyl-1,3-propanediamine), dimethylzinc·TEEDA, dimethylzinc·TMEDA, and dimethylzinc·TMPDA.

Other suitable zinc-containing compounds include, for example, zinc carboxylates (e.g., zinc acetate, zinc propionate), zinc diketonates (e.g., zinc acetyl acetonate, zinc hexafluoroacetyl acetonate), dialkyl zinc compounds (e.g., diethyl zinc, dimethyl zinc), zinc chloride and the like.

When zinc is included as a precursor, a method of forming a doped layer comprised of zinc oxide on a polymer substrate comprises contacting a polymer substrate with at least one precursor comprising zinc and a dopant, and applying an ultraviolet light to decompose the at least one precursor and to deposit a layer comprising doped zinc oxide onto the polymer substrate. Accordingly to a preferred embodiment, the transparent conducting oxide layer is a doped zinc oxide layer. The zinc oxide layer, however, may be doped or not.

In an embodiment of the present invention, the at least one precursor comprises a dopant. Any suitable dopants, as recognized by one skilled in the art, may be utilized. For example, dopants that are commonly used in a chemical vapor deposition process may be employed. The dopant is preferably introduced in a gaseous phase. In a preferred embodiment, the dopant is at least one metal selected from the group consisting of Al, Ga, In, Tl, and B. More preferably, the dopant is Ga.

For example, the precursor composition may be comprised of one or more group 13 metal-containing precursors include those of the general formula:

R⁹₍₃₋ₙ₎M(R¹⁰C(O)CR¹¹₂C(O)R¹²)ₙ or R⁹₃M(L)

wherein M=B, Al, Ga, In or Tl, R⁹ is an alkyl or aryl or halide or alkoxide group, R¹⁰⁻¹² may be the same or different and are H, alkyl, or aryl groups (including cyclic and partially- and perfluorinated derivatives), n=0-3, and L=a neutral ligand capable of coordinating to the metal. A preferred gallium-containing precursor is dimethylgalliumhexafluoroacetylacetonate (commonly referred to as Me₂Ga(hfac)). Other suitable gallium-containing precursors may include diethylgallium (hexafluoroacetylacetonate), trimethylgallium, trimethylgallium (tetrahydrofuran), triethylgallium (tetrahydrofuran), dimethylgallium (2,2,6,6-tetramethyl-3,5-heptanedionate), dimethylgallium (acetylacetonate), tris(acetylacetonate)gallium, tris(1,1,1-trifluoroacetylacetonate)gallium, tris(2,2,6,6-tetramethyl-3,5-heptanedionate)gallium and triethylgallium. Other gallium-containing compounds may also be suitable for use as precursors in the present invention.

Suitable aluminum-containing precursors may include R¹_{(3-n)AlR}²ₙ and R¹₃Al(L), where R¹ is methyl, ethyl, n-propyl, isopropyl, n-butyl, isobutyl, or octyl, R² is a halide or substituted or unsubstituted acetylacetonate derivative, including partially- and perfluorinated derivatives, n is 0-3, and L is a neutral ligand capable of coordinating to aluminum. Preferred aluminum containing precursors may include diethyl aluminum acetylacetonate (Et₂Al(acac)), diethylaluminum chloride, diethylaluminum(hexafluoroacetylacetonate), diethylaluminum(1,1,1-trifluoroacetylacetonate), diethylaluminum(2,2,6,6-tetramethyl-3,5-heptanedionate), triethylaluminum, tris(n-butyl)aluminum, and triethylaluminum(tetrahydrofuran). Other aluminum-containing compounds may be suitable for use as precursors in the present invention.

Suitable boron-, indium- and thallium-containing compounds that can be utilized as dopant precursors include diborane as well as compounds analogous to the aluminum- and gallium-containing compounds mentioned above (e.g., compounds where a B, In or Tl atom is substituted for Al or Ga in any of the aforementioned aluminum- or gallium-containing precursors).

The amount of dopant (e.g., Al, B, Tl, In, Ga species, such as oxides) in the final doped oxide coating can be controlled as desired by controlling the composition of the precursor vapor, e.g., the relative amounts of the precursors. In one embodiment, the oxide coating comprises about 0.1% to about 5%, or about 0.5% to about 3%, by weight of dopant oxide.

Additional components may be admixed with the precursors before or simultaneous with contacting the precursor vapor with the substrate.

Such additional components or precursors may include, for example, oxygen-containing compounds, particularly compounds that do not contain a metal, such as esters, ketones, alcohols, hydrogen peroxide, oxygen (O₂), or water. One or more fluorine-containing compounds (e.g., fluorinated alkanes, fluorinated alkenes, fluorinated alcohols, fluorinated ketones, fluorinated carboxylic acids, fluorinated esters, fluorinated amines, HF, or other compounds that contain F but not a metal) may also be utilized as an additional component. The precursor vapor may be admixed with an inert carrier gas such as nitrogen, helium, argon, or the like.

In an embodiment of the present invention, a method of forming a layer on a polymer substrate comprises contacting a polymer substrate with at least one precursor, and applying ultraviolet light to decompose the at least one precursor and deposit a layer onto the polymer substrate. In a preferred embodiment, the contacting step and/or the applying the UV light step may occur at low temperature conditions. In particular, low temperature conditions may occur at less than about 400° C. In an exemplary embodiment, the UV application step occurs at less than about 200° C., e.g., 100-200° C. preferably about 160-200° C. In a preferred embodiment, the UV application step occurs at about 160-200° C. For example, when a chemical vapor deposition process is utilized, it is envisioned that the low temperature conditions may occur at any time during the process, preferably during the entire process to minimize adverse effects to the polymer substrate. Any suitable conditions may be employed during the contacting and applying steps. For example, the contacting step and/or the application step may be carried out at about atmospheric pressure. Accordingly, in a preferred embodiment, the process is an atmospheric pressure chemical vapor deposition (APCVD) process. Any other suitable conditions or techniques may also be used, such as low pressure chemical vapor deposition (LPCVD), plasma-enhanced chemical vapor deposition (PECVD), physical vapor deposition, etc.

It is also recognized that the contacting and applying steps may occur in any suitable order. For example, in chemical vapor deposition, a gas flow comprising the at least one precursor is introduced into a deposition chamber. The gas may flow in streamlines through the reactor. The precursor, its constituents, or reactant products may diffuse across the streamlines and contact the surface of the substrate. As the precursors activate and decompose, they deposit onto the substrate and form the film or layer. Accordingly, the contacting may occur from the precursor and/or its activated/decomposed product to the polymer substrate. Accordingly, a method of forming a layer on a polymer substrate may comprise introducing at least one precursor onto a polymer substrate, and applying an ultraviolet light to decompose the at least one precursor and to deposit a layer onto the polymer substrate. In a preferred embodiment, the method is a chemical vapor deposition process.

When using a chemical vapor deposition process, the precursors comprising zone, a dopant and an oxygen source in the gas phase are injected into a mixing chamber, subsequently pass through a UV chamber, subsequently depositing onto a polymer substrate, a layer comprising doped zinc oxide. The chemical vapor deposition process may also occur during a roll to roll (or web) process where the deposition occurs on a roll of the polymer substrate, e.g., in a continuous process.

The processes disclosed herein produce a layer, optionally a doped layer, deposited on a polymer substrate. Incorporation of non-activated precursors (in a partially decomposed state) is minimized or avoided in the layer. The deposition process may occur to produce a single layer of TCO or multiple layers of TCO. The layers may be the same or different layers of TCO. The TCO film may be of any suitable thickness. For example, the film may be in the range of about 1000-8000 Å. In a particular embodiment, the deposition process may produce a gallium-doped zinc oxide film.

The TCO layer preferably is of high quality having excellent electrical and optical properties. It is preferred that the properties of the TCO layer, especially the doped zinc oxide, are at least comparable if not better than a tin-doped indium oxide (ITO). For example, an ITO may exhibit uniform conductivity, for example, in the range of about 1×10⁻⁴ Ωcm to 3×10⁻⁴ Ωcm. In an exemplary embodiment, the transparent conducting oxide layer has a resistivity of less than about 1×10⁻³ Ωcm. The layer should also demonstrate good optical properties. In particular, the TCO may provide visible transmission of greater than 80%, more preferably greater than 90%.

Using embodiments of the present invention, it is possible to obtain coatings that are electrically conductive, transparent to visible light, reflective to infrared radiation and/or absorbing to ultraviolet light. For example, zinc oxide-coated transparent substrate materials exhibiting high visible light transmittance, low emissivity properties and/or solar control properties as well as high electrical conductivity/low sheet resistance can be prepared by practice of the present invention.

Additionally, it is envisioned that the TCO layer exhibits good durability, for example by demonstrating good adhesion to the substrate (e.g., the coating will not delaminate over time). Also, the TCO layer is stable to undergo an annealing process (e.g., dopant atoms may diffuse into substitutional positions in the crystal lattice to cause changes in the electrical properties).

Possible applications of TCO films made in accordance with the present invention include, but are not limited to, thin film photovoltaic (PV) and organic photovoltaic (OPV) devices, flat panel displays, liquid crystal display devices, solar cells, electrochromic absorbers and reflectors, energy-conserving heat mirrors, antistatic coatings (e.g., for photomasks), solid state lighting (LEDs and OLEDs), induction heating, gas sensors, optically transparent conductive films, transparent heater elements (e.g., for various antifogging equipment such as freezer showcases), touch panel screens, and thin film transistors (TFTs), as well as low emissivity and/or solar control layers and/or heat ray reflecting films in architectural and vehicular window applications and the like. In a preferred embodiment, the TCO films may be used as thin film PV and OLEDs (more specifically, OLED lighting).

### EXAMPLES

Al or Ga-doped zinc oxide (ZnO) films were deposited using an ultra violet-chemical vapor deposition (UV-CVD) method. The deposition process differs from traditional atmospheric pressure chemical vapor deposition, in that a UV light source is utilized to activate the precursors and promote deposition at low substrate temperature. The zinc precursor used in the process was a complex of dimethyl zinc and methylTHF. The Al and Ga dopants are diethyl aluminum acetylacetonate (Et₂Al(acac)) and dimethyl gallium acetylacetonate (Me₂Ga(acac)), respectively. The oxidant used in the process was either water or a mixture of water and alcohol. Nitrogen was used as a carrier gas to carry both the precursor vapor and oxidant vapor to the CVD mixing chamber prior to deposition on a substrate. The Zn and dopant precursors were kept in steel bubblers, and nitrogen carrier gas flowed through the bubblers and carried the precursor vapor to the mixing chamber. The experimental parameters are listed in Table 1. A variety of UV light sources were tested to activate the deposition process: Hanovia medium pressure mercury lamp, Heraeus low pressure amalgam lamp and Heraeus high pressure metal halide lamp. Both the medium pressure mercury lamp and high pressure metal halide lamp generate a broad spectrum of radiation covering from UVC (˜220 nm) to infrared, whereas the low pressure amalgam lamp generates UV radiation at two wavelengths, 185 and 254 nm. The energy flux at 185 and 254 nm are 9 and 30 W, respectively.

TABLE 1

| Zn | | | Al | | | Water | | | | Coater | |
|---|---|---|---|---|---|---|---|---|---|---|---|
| Flow | Bath | Line | Flow | Bath | Line | Flow | Injection | Line | Carrier | Head | Substrate |
| Rate | Temp | Temp | Rate | Temp | Temp | Rate | Rate | Temp | Gas | Temp | Temp |
| (ml/min) | (Deg C.) | (Deg C.) | (ml/min) | (Deg C.) | (Deg C.) | (l/min) | (ml/hr) | (Deg C.) | (l/min) | (Deg C.) | (Deg C.) |
| 100 | 66 | 70 | 300 | 66 | 70 | 6 | 15 | 160 | 10 | 160 | R.T.-200 |

### Example 1

### Hanovia Medium Pressure Mercury Lamp

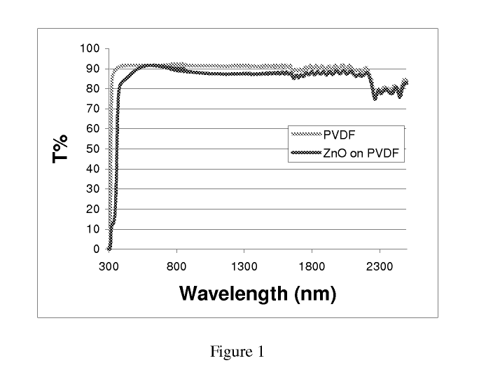

Doped ZnO films by UV-CVD were deposited using a photochemical reaction vessel. A Hanovia medium pressure mercury lamp was used as the UV light source. Polyvinylidene fluoride (PVDF) films were wrapped around the cooling quartz sleeve as substrates, and precursors and oxidants were fed into the reaction vessel by nitrogen carrier gas. The deposition time was about 1-2 min. The film thickness is about 160 nm. A good coating was obtained with uniform film thickness and good adhesion to the PVDF substrate, but the conductivity was not uniform. The Al-doped ZnO film was conductive in some areas up to 1×10⁻³ Ωcm. FIG. 1 shows that the film was highly transparent in the visible light region with >90% transmission.

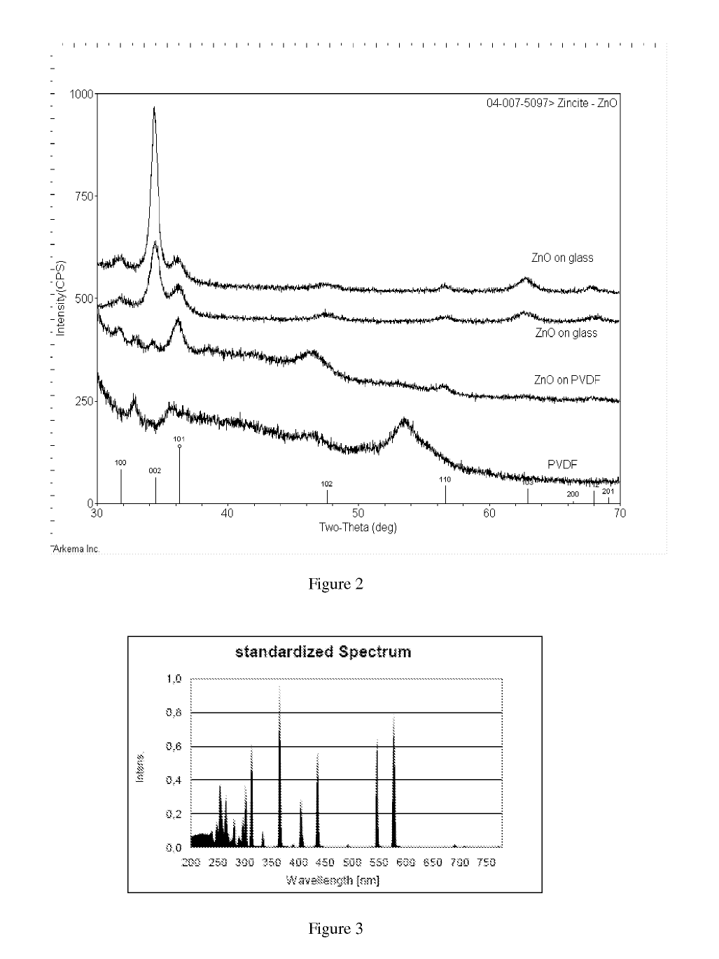

FIG. 2 shows the X-ray diffraction (XRD) patterns of the ZnO on glass, ZnO on PVDF, and PVDF alone. The diffraction patterns show that ZnO can be deposited by UV-CVD on different substrates, particularly a polymer substrate, such as PVDF. The preferred crystal orientation depends on the substrates used, i.e., (002) dominates on a glass substrate whereas (101) dominates on PVDF.

### Example 2

### High Pressure Hg Metal Halide Lamp

A high pressure He metal halide lamp manufactured by Heraeus was used as UV light source in the low temperature deposition of conductive ZnO films on polymer and glass substrates. FIG. 3 shows the spectrum of the lamp, and the total power of this lamp is 400 W.

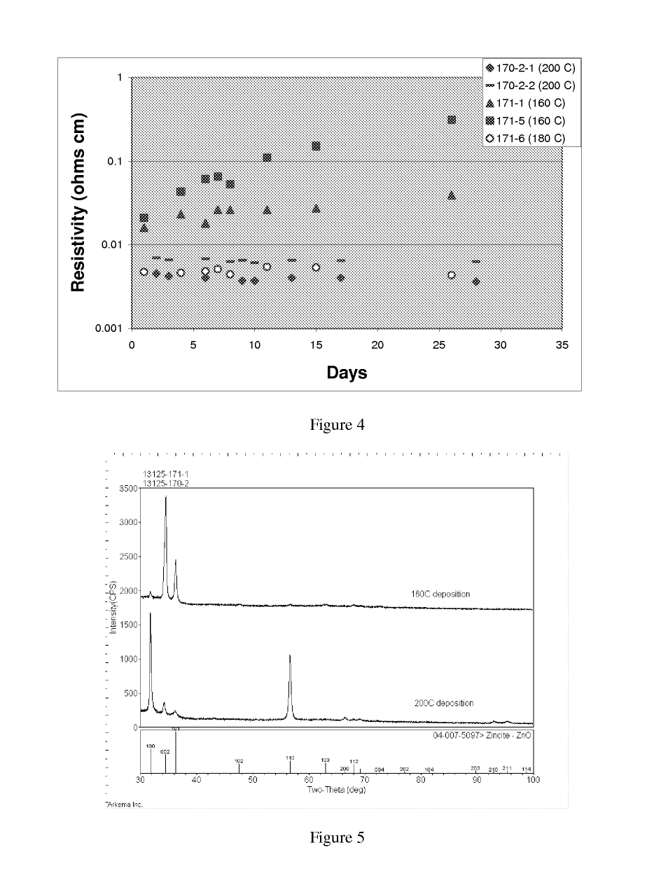

Using the high pressure Hg metal halide lamp, Al-doped ZnO films were deposited on glass, polyetherketoneketone and KAPTON® (registered trademark of E.I. DuPpont de Nemours and Co.) at substrate temperature ranging from room temperature to 200° C. The ZnO films were not conductive when substrate temperature was at or below 130° C., whereas the films were conductive when the substrate temperature was at or above 160° C. This shows that the deposition process is activated by a combination of UV and thermal energy. The most conductive Al-doped ZnO films have sheet resistance and resistivity of about 60 ohms/square and about 4.0×10⁻³ ohms cm, respectively. The stability of the conductive ZnO films over time is very important for maintaining the performance and stability of devices such as organic light emitting diodes, photovoltaics and flexible displays. FIG. 4 shows the resistivity as a function of time when the ZnO films were kept at ambient condition after deposition. The films were deposited at different substrate temperatures. Sample 171-6 was deposited on KAPTON® film at 180° C., whereas the others were deposited on glass substrates. Samples 171-1 and 171-5 were deposited at 160° C. The ZnO films deposited at relatively higher temperature (180 and 200° C.) maintain the conductivity after about 1 month, whereas the films deposited at 160° C. lose some conductivity gradually with time.

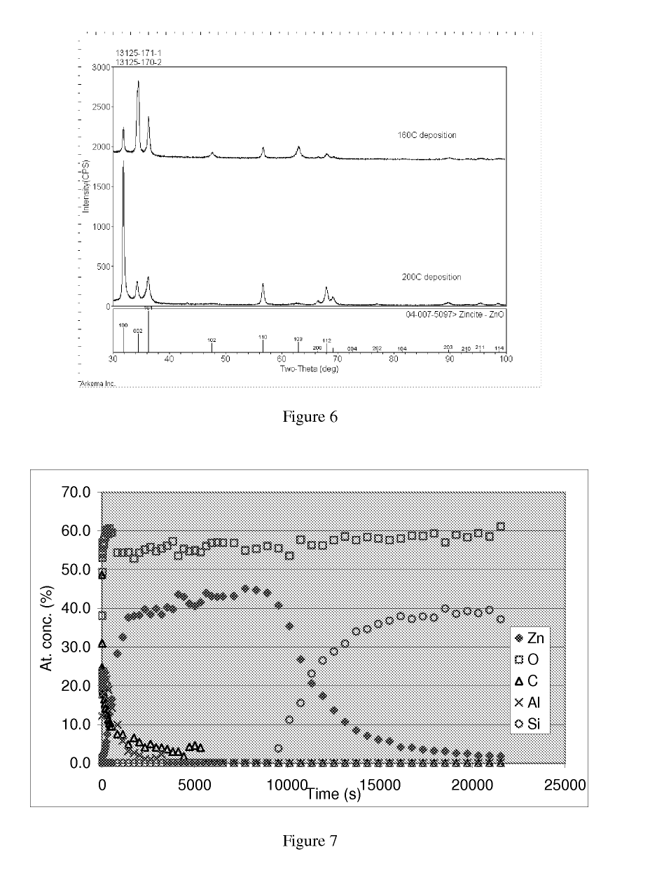

FIGS. 5 and 6 show the x-ray diffraction patterns of the ZnO films in the bulk and on the surface, respectively. Both figures show that the films are ZnO films with characteristic ZnO diffraction peaks. In the bulk of the samples, the c-axis of ZnO unit cell (002) is essentially perpendicular to the plane of the sample for sample 171-1 whereas it is essentially laying within the plane of the sample for sample 170-2. Nearer the top surface of the samples important crystallographic differences are seen between the two samples. Sample 171-1 shows a more random orientation near the surface than in the bulk. Sample 170-2 maintains a strong preferred orientation near the surface and the c-axis of the ZnO unit cell (002) remains well within the sample's plane compared to Sample 171-1. The a-axis (100) is strongly oriented along the sample's normal.

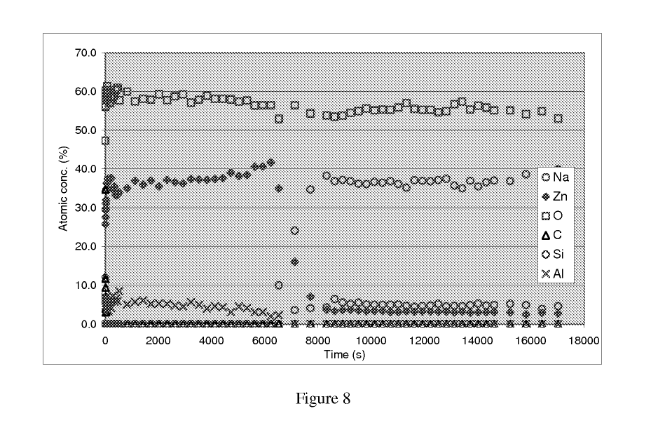

At the very top of 170-2 thin film is a thin layer made up of C, Al and O. It then becomes a thin layer of O, Zn, Al and C. The next layer, by far the thicker within the thin film, is Zn, O, some C and some Al. Sample 170-2 has an Al concentration gradient with a surface-rich in Al. FIG. 7 is a depth profile of sample 170-2. FIG. 8 is a depth profile of sample 171-1. Sample 170-2 had good conductivity and also maintains the conductivity at ambient conditions. Sample 171-1 has a more traditional looking concentration profile as seen in FIG. 4 and shows very stable profile concentrations for Zn, O and Al. However, sample 171-1 has a lower electrical conductivity than sample 170-2.

Both sample 170-2 and sample 171-1 are oxygen-rich doped ZnO films, and the [Zn] and [O] are 35-45% and 55-60% respectively.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method of forming a layer on a polymer substrate comprising:
(a) contacting a polymer substrate with at least one precursor; and
(b) applying ultraviolet light to decompose the at least one precursor and deposit a layer onto the polymer substrate.

2. A method of forming a layer on a polymer substrate according to claim 1, wherein the at least one precursor comprises a dopant.

3. A method of forming a layer on a polymer substrate according to claim 2, wherein the dopant is at least one metal selected from the group consisting of Al, Ga, In, Tl, and B.

4. A method of forming a layer on a polymer substrate according to claim 1, wherein the at least one precursor comprises zinc.

5. A method of forming a layer on a polymer substrate according to claim 4, wherein the layer is a doped zinc oxide layer.

6. A method of forming a layer on a polymer substrate according to claim 1, wherein the layer is a transparent conducting oxide layer.

7. A method of forming a layer on a polymer substrate according to claim 6, wherein the transparent conducting oxide layer has a resistivity of less than about 1×10⁻³ Ωcm.

8. A method of forming a layer on a polymer substrate according to claim 1, wherein step (b) occurs at less than about 200° C.

9. A method of forming a layer on a polymer substrate according to claim 1, wherein step (b) occurs at about 160-200° C.

10. A method of forming a layer on a polymer substrate according to claim 1, wherein the at least one precursor is introduced in a gas phase in step (a).

11. A method of forming a layer on a polymer substrate according to claim 1, wherein said contacting is carried out at about atmospheric pressure.

12. A method of forming a layer on a polymer substrate according to claim 1, wherein the polymer substrate is selected from the group consisting of fluoropolymer resins, polyesters, polyacrylates, polyamides, polyimides, and polycarbonates.

13. A method of forming a layer on a polymer substrate according to claim 1, wherein the polymer substrate is selected from the group consisting of polyvinylidene fluoride (PVDF), polyethylene terephthalate (PET), polyethylene naphthalate (PEN), and polymethyl methacrylate (PMMA).

14. A method of forming a layer on a polymer substrate according to claim 1, wherein the ultraviolet light activates the at least one precursor.

15. A method of forming a layer on a polymer substrate according to claim 1, wherein the ultraviolet light has a wavelength of about 180-310 nm.

16. A method of forming a layer on a polymer substrate according to claim 1, wherein the method is a chemical vapor deposition process.

17. A method of forming a doped layer comprised of zinc oxide on a polymer substrate comprising:
(a) contacting a polymer substrate with at least one precursor comprising zinc and a dopant; and
(b) applying an ultraviolet light to decompose the at least one precursor and to deposit a layer comprising doped zinc oxide onto the polymer substrate.

18. A doped layer comprising zinc oxide deposited on a polymer substrate obtained by:
(a) introducing at least one precursor comprising zinc and a dopant into a vessel containing a polymer substrate; and
(b) applying an ultraviolet light to decompose the at least one precursor and to deposit a layer comprising doped zinc oxide onto the polymer substrate.
